(19) United States
(12) Patent Application Publication
(10) Pub. No.: US 2026/0167284 A1
(43) Pub. Date: Jun. 18, 2026

(54) SPROCKET BASED CARRIER ROLLER FOR WASTE HANDLER DOZERS

(71) Applicant: Deere & Company, Moline, IL (US)

(72) Inventors: Nishant G. Masane, Pune (IN); Michael R. Tigges, Dubuque, IA (US); Neelam Sarma, Guwahati (IN); Trent A. Luoma, Dubuque, IA (US); Rajeev Kumar, Patna (IN)

(21) Appl. No.: 18/979,836

(22) Filed: Dec. 13, 2024

(51) Int. Cl. B62D 55/14

(52) U.S. Cl. CPC B62D 55/14

(57) ABSTRACT

A carrier roller is mounted on a track frame and supports an upper strand of an endless linked chain, the carrier roller includes a generally cylindrical carrier roller body having an axis of rotation and a carrier sprocket extending radially relative to the axis of rotation so that the carrier sprocket is concentric with the generally cylindrical carrier roller body. The carrier sprocket includes a plurality of teeth separated by concave valleys configured to receive the cylindrical bushings of the endless linked chain in the concave valleys between the teeth, the concave valleys between the teeth being radially offset from the generally cylindrical carrier roller body such that a weight of the upper strand of the endless linked chain is primarily carried by the engagement of the concave valleys with the cylindrical bushings of the endless linked chain.

### BACKGROUND OF THE DISCLOSURE

### 1. Field of the Disclosure

The present disclosure relates to an endless track for a track-type vehicle, and, more particularly, to a carrier roller design for use in a waste handler dozer.

### 2. Description of the Prior Art

Track-type vehicles (e.g., crawlers, excavators, tracked tree-felling machines) have an undercarriage typically with at least one track on each side of the vehicle. Each track typically includes an endless track chain, with ground-engaging shoes mounted thereon, trained about a drive sprocket, one or more idlers, and rollers.

One such track-type vehicle is a waste handler dozer which is especially designed for waste management in dump yards. A problem encountered with waste handler dozers is the jamming of the carrier rollers of the tracks due to accumulated debris. Waste materials, such as plastic, metal, organic matter and the like may accumulate around the internal cavities of the tracks, especially around the rotating components such as the rollers and drive sprockets leading to obstruction and jamming. The jamming of rollers, particularly the carrier rollers, is sometimes so severe that the rollers stop rotating and the chain just skids over the static roller. This flattens the rollers due to the immense load from the chain.

With the prior art track designs, this accumulated waste needs to be cleaned out, for example once per operating shift, using low-pressure high-volume water jets. There may be two or three shifts per day. This frequent machine downtime is costly for the machine operators.

There is a need for improved designs for track chains to eliminate the problems noted above.

### SUMMARY OF THE DISCLOSURE

The present disclosure provides an improved carrier roller design having a positive drive sprocket instead of a plain roller. The positive drive sprocket roller forces rotation of the roller due to interaction of the sprocket with the track chain bushings. This helps prevent roller jamming.

In one embodiment a crawler track assembly includes a track frame, and a drive sprocket and an idler sprocket mounted on the track frame. An endless linked chain includes first and second rows of links joined by cylindrical bushings extending between the first and second rows of links, the chain extending around the drive sprocket and the idler sprocket. A plurality of lower rollers are mounted on the track frame and engage a lower strand of the endless linked chain. At least one carrier roller is mounted on the track frame and supports an upper strand of the endless linked chain, the carrier roller including a generally cylindrical carrier roller body having an axis of rotation and a carrier sprocket extending radially relative to the axis of rotation so that the carrier sprocket is concentric with the generally cylindrical carrier roller body. The carrier sprocket includes a plurality of teeth separated by concave valleys configured to receive the cylindrical bushings of the endless linked chain in the concave valleys between the teeth, the concave valleys between the teeth being radially offset from the generally cylindrical carrier roller body such that a weight of the upper strand of the endless linked chain is primarily carried by the engagement of the concave valleys with the cylindrical bushings of the endless linked chain.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side elevation view of a simplified track-type vehicle (e.g., crawler dozer) having an undercarriage shown diagrammatically.

FIG. 2 is an enlarged side elevation view showing an endless track chain trained about a drive sprocket.

FIG. 3 is a plan view showing the track chain trained about a drive sprocket.

FIG. 4 is an enlarged plan view of one link assembly.

FIG. 5 is a side elevation view of the link assembly of FIG. 4.

FIG. 6 is a perspective view of the link assembly of FIG. 4.

FIG. 7 is an enlarged cross-section view of the track bushing.

FIG. 8 is an end view of the sprocket type carrier roller.

FIG. 9 is a section view of the sprocket type carrier roller taken along line 9-9 of FIG. 8.

FIG. 10 is an enlarged view showing the sprocket type carrier roller mounted on the track frame and supporting an upper strand of the endless chain of the track.

### DETAILED DESCRIPTION

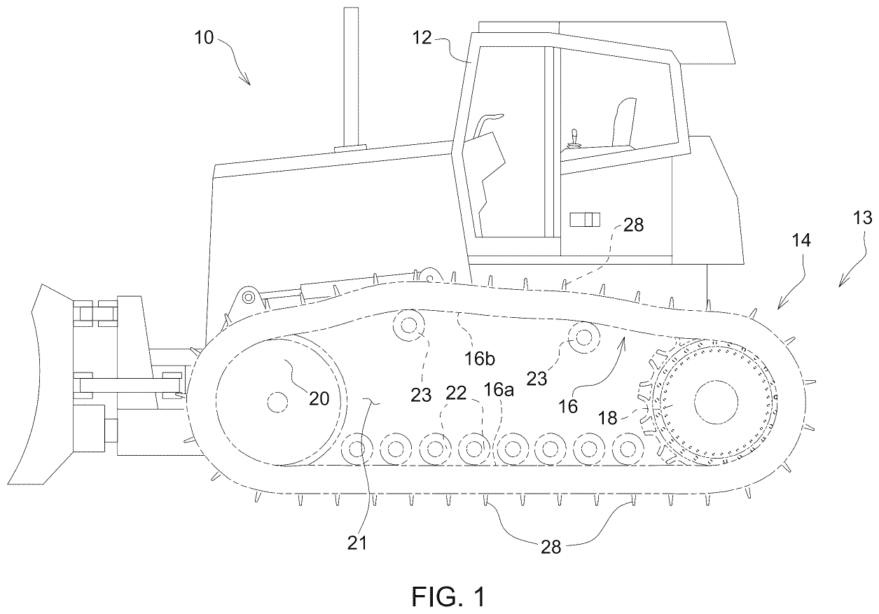

Referring to FIG. 1, there is shown a simplified track-type vehicle 10, illustratively a crawler dozer, although it could be any track-type vehicle. The vehicle 10 includes an operator's station 12 from which a human operator can control functions of the vehicle 10 including propulsion and steering. The undercarriage 13 of the vehicle 10 has a track 14 on each side of the vehicle 10 for propulsion and steering of the vehicle 10. In the illustrated example, each track 14 is trained about a rear drive sprocket 18, a front idler 20, a number of load bearing lower rollers 22, and a number of carrier rollers 23 which support the upper strand of the track. A track frame 21 of the undercarriage 13 is attached to the base machine and is located between the drive sprocket 18 and the idler 20 within the track 14, and the idler 20 and the lower rollers 22 and carrier rollers 23 are attached to the track frame 21. In the embodiment illustrated there is a forward carrier roller 23 and a rearward carrier roller 23.

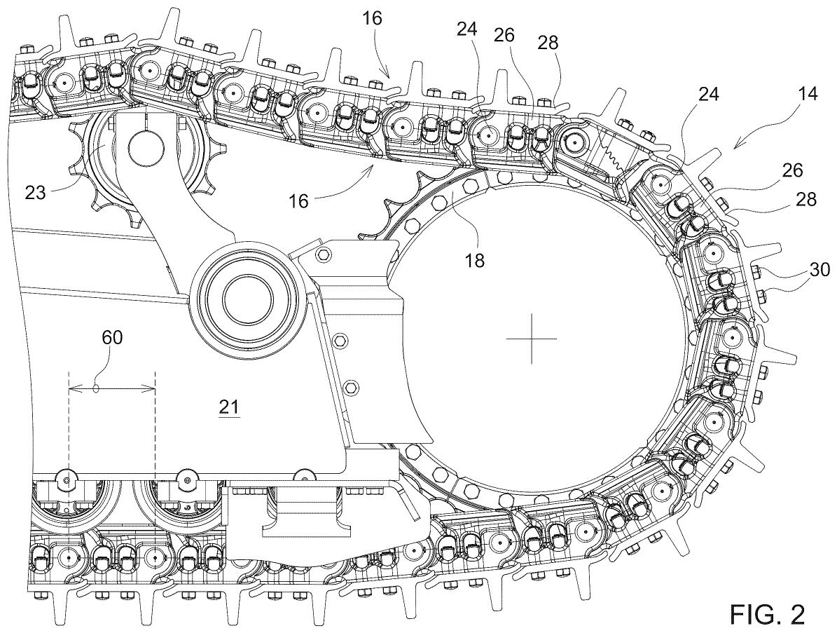

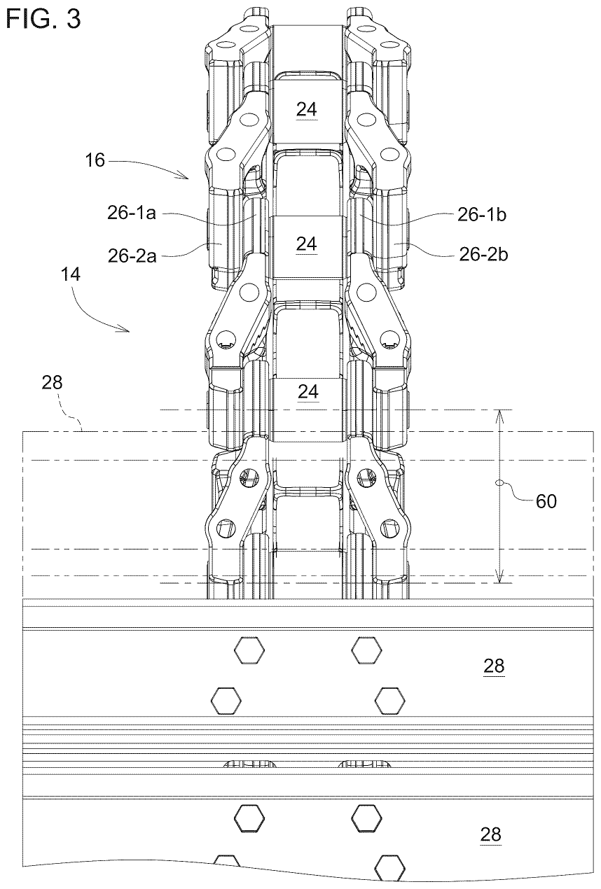

Referring to FIGS. 2 and 3, each track 14 includes an endless track chain 16 and ground-engaging shoes 28 attached to the chain 16. The chain 16 includes a number of joints each of which may be configured as a track bushing 24, a track pin 32, and links 26 interconnected by the track bushings 24 and track pin 32. Additionally, master links (not shown), may be used in a known manner to close the endless track chain 16.

Shoes 28 are attached to the links 26 via bolts 30. Each track bushing 24 with a corresponding track pin 32 acts as a pivot for links 26 attached to that track bushing 24. Further, as a wear component, each track bushing 24 engages the drive sprocket 18 between the teeth thereof and the idler 20 during advancement of the track 14.

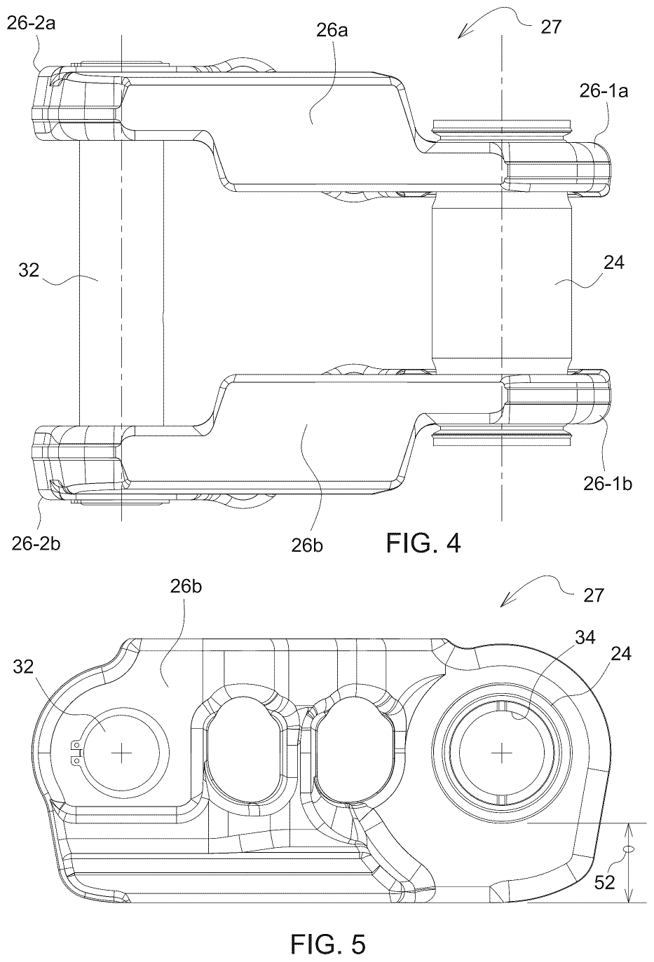

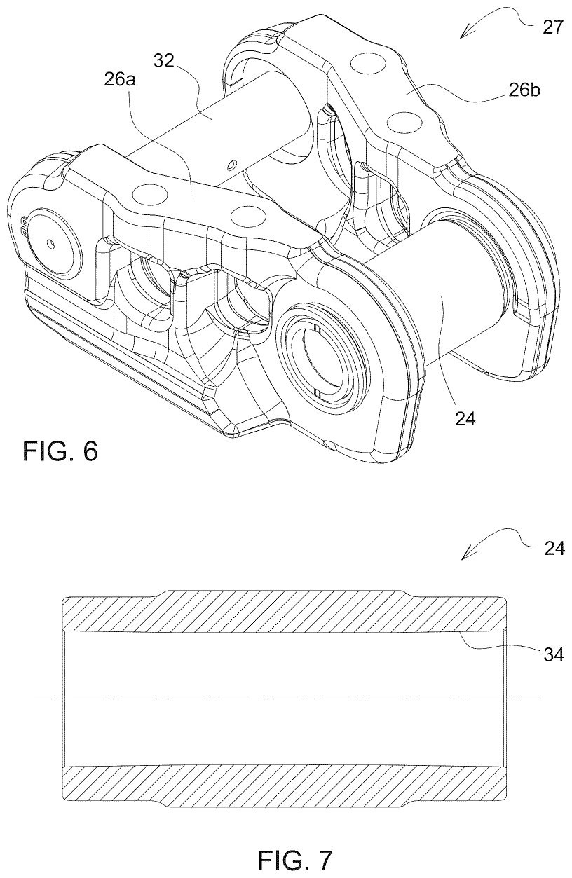

The details of construction of one example of a link assembly 27 are shown in FIGS. 4-6. Each link assembly 27 includes two links 26a, 26b, a track bushing 24 and a track pin 32. The track links may collectively be referred to as links 26. A joint between two link assemblies 27 is seen in the plan view of FIG. 3. Each link assembly 27 includes two inner link ends 26-1a and 26-1b on one end and two outer link ends 26-2a and 26-2b on the other end. The two inner link ends 26-1a and 26-1b are joined by the track bushing 24. The two outer link ends 26-2a and 26-2b are joined by the track pin 32. When forming a joint between two adjacent link assemblies 27 as seen in FIG. 3 the outer link ends 26-2a and 26-2b of one link assembly 27 are received about the inner link ends 26-1a and 26-1b of the adjacent link assembly 27 and the track pin 32 is received through a bore 34 of the corresponding track bushing 24 to pivotally join the two adjacent link assemblies 27.

The track chain 16 may generally be described as an endless linked chain 16 including first and second rows of links 26a, 26b, joined by cylindrical bushings 24 extending between the first and second rows of links, the chain extending around the drive sprocket 18 and the idler sprocket 20. The plurality of lower rollers 22 mounted on the track frame 21 engage a lower strand 16a of the endless linked chain 16, and the carrier rollers 23 support an upper strand 16b of the endless linked chain 16.

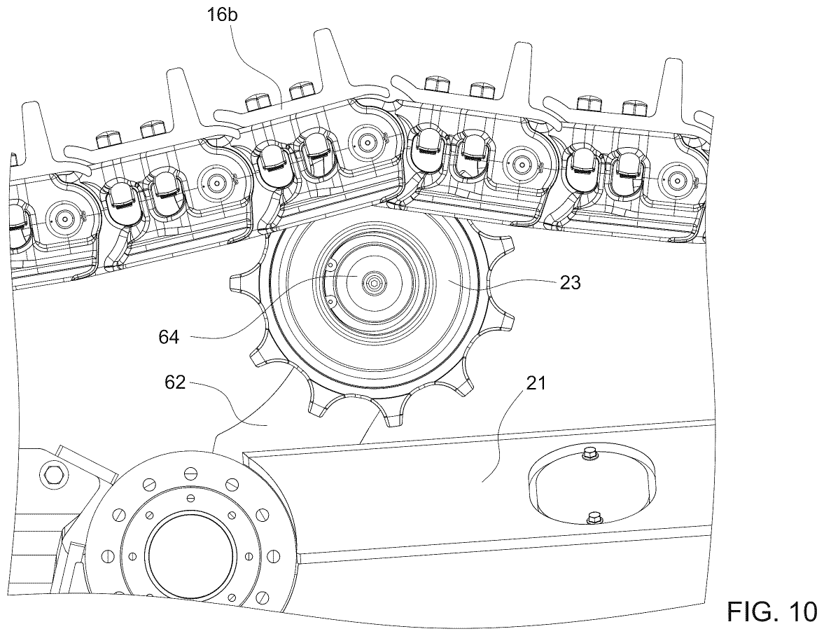

The present disclosure is focused on the construction of the carrier rollers 23 and their relationship to the structure of the chain 16. The purpose of the carrier rollers 23 is to support the weight of the upper strand 16b of the chain 16 that is suspended between the drive sprocket 18 and the front idler 20. FIG. 10 shows an enlarged view of one of the carrier rollers 23 mounted on the track frame 21 and supporting the upper strand 16b of the chain 16. As seen in FIG. 10 the track frame 21 may include a frame arm 62 holding a cantilevered shaft 64 on which the carrier roller 23 is rotatably mounted.

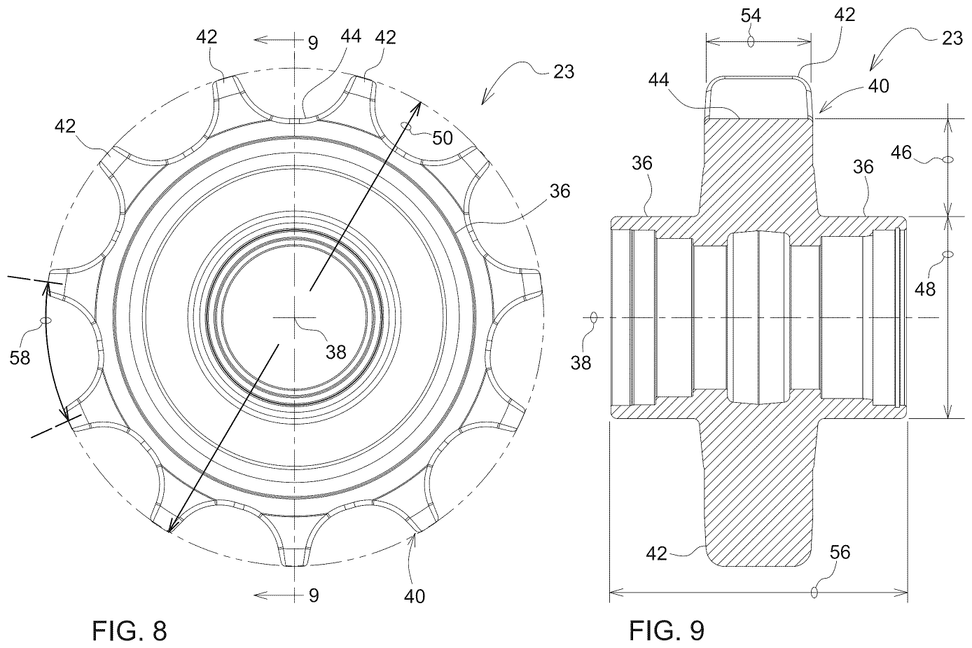

As is best shown in FIGS. 8 and 9, each carrier roller 23 includes a generally cylindrical carrier roller body 36 having an axis of rotation 38 and a carrier sprocket 40 extending radially relative to the axis of rotation 38 so that the carrier sprocket 40 is concentric with the generally cylindrical carrier roller body 36. The carrier sprocket 40 includes a plurality of teeth 42 separated by concave valleys 44 configured to receive the cylindrical bushings 24 of the endless linked chain 16 in the concave valleys 44 between the teeth 42. The concave valleys 44 between the teeth 42 are radially offset by an offset distance 46 from the generally cylindrical carrier roller body 36 such that a weight of the upper strand 16b of the endless linked chain 16 is primarily carried by the engagement of the concave valleys 44 with the cylindrical bushings 24 of the endless linked chain 16.

The radial offset distance 46 of the concave valleys 44 from the generally cylindrical carrier roller body 36 should be sufficient to prevent the first and second rows of links 26a, 26b, from resting on the generally cylindrical carrier roller body 36.

In one example, a diameter 48 of the cylindrical carrier roller body 36 may be about 162 mm (6.4 inches) and a diameter 50 of the carrier sprocket 40 may be about 400 mm (15.7 inches), and the radial offset distance 46 may be about 75 mm (3.0 inches). The corresponding chain links 26 may extend below the bushing 24 by a skirt depth 52 as seen in FIG. 5, which skirt depth 52 may be about 45 mm (1.8 inches). The concave valleys 44 may have a width 54 parallel to the axis of rotation 38 of about 87 mm (3.4 inches). The cylindrical carrier roller body 36 may have a length 56 of about 237 mm (9.3 inches).

Thus, in the example just stated, the skirt depth 52 is substantially less than the radial offset distance 46 such that the first and second rows of links 26a, 26b, are prevented from resting on the generally cylindrical carrier roller body 36. The radial offset 46 of the concave valleys 44 from the generally cylindrical carrier roller body 36 may be at least 2.0 inches, and preferably at least 2.5 inches, and more preferably about 3.0 inches. The concave valleys 44 may have a width 54 parallel to the axis of rotation 38 of at least 3.0 inches.

With such a design the concave valleys 44 between the teeth 42 are radially offset by the distance 46 from the generally cylindrical carrier roller body 36 such that the weight of the upper strand 16b of the endless linked chain 16 is primarily carried by the engagement of the concave valleys 44 with the cylindrical bushings 24 of the endless linked chain 16. As seen in FIG. 10, the adjacent links 26 of the chain 16 may touch the outer surface of the cylindrical carrier roller body 36 due to their angular inclination about the bushing 24 which is at that moment in time received in one of the valleys 44, but the majority of the weight of the chain 16 is carried by the engagement of the bushing 24 with the valley 44, rather than by engagement of the links 26 with the outer cylindrical surface of the cylindrical carrier roller body 36.

As best seen in FIG. 8, the carrier sprocket 40 of carrier roller 23 may include an odd number of teeth 42. In the example illustrated the carrier sprocket 40 includes eleven teeth 42. The carrier sprocket could include less than or more than eleven teeth, but in one embodiment the carrier sprocket 40 includes at least eleven teeth.

The carrier sprocket 40 has a pitch 58 between adjacent teeth 42. The pitch 48 is preferably one-half a chain pitch 60 (see FIG. 3) between adjacent bushings 24 of the endless chain 16. With this arrangement as the carrier sprocket 40 rotates, adjacent bushings 24 skip one valley 44 of the carrier sprocket 40. Due to the odd number of teeth 42 and valleys 44, on the next rotation the bushings 24 engage the valleys that were skipped in the prior rotation.

In one embodiment the carrier roller 23 is formed as an integrally forged part including the generally cylindrical carrier roller body 36 and the carrier sprocket 40. In another embodiment the carrier roller 23 may be formed as an inner part including the generally cylindrical carrier roller body 36 and an outer part including the carrier sprocket 40, which inner and outer parts are then joined together such as by welding.

A number of advantages are provided by the disclosed sprocket type carrier rollers 23. The positive drive provided by the engagement of the sprocket teeth 42 with the bushings 24 of the track chain 16 ensures that the carrier rollers 23 will always rotate, thereby preventing jamming due to accumulation of debris around the carrier rollers 23. The positive engagement between the sprocket teeth 42 and the bushings 24 of the track chain 16 also eliminates skidding of the track chain 16 over the roller bodies 36, thereby preventing localized strain on the rollers. The carrier rollers 23 may each be forged as an integral part, and then heat treated to withstand significant wear, making them suitable for use in harsh operating environments. Improved track life is provided. The design is versatile and can be used on many different types of tracked equipment. Serviceability of the tracks is improved. There is reduced downtime due to reduced maintenance and cleaning. All of the above results in a significant cost reduction to users of the tracked vehicle.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A crawler track assembly for use with a tracked vehicle, the crawler track assembly comprising:
a track frame;
a drive sprocket mounted on the track frame;
an idler sprocket mounted on the track frame;
an endless linked chain including first and second rows of links joined by cylindrical bushings extending between the first and second rows of links, the chain extending around the drive sprocket and the idler sprocket;
a plurality of lower rollers mounted on the track frame and engaging a lower strand of the endless linked chain; and
at least one carrier roller mounted on the track frame and supporting an upper strand of the endless linked chain, the carrier roller including a generally cylindrical carrier roller body having an axis of rotation and a carrier sprocket extending radially relative to the axis of rotation so that the carrier sprocket is concentric with the generally cylindrical carrier roller body, the carrier sprocket including a plurality of teeth separated by concave valleys configured to receive the cylindrical bushings of the endless linked chain in the concave valleys between the teeth, the concave valleys between the teeth being radially offset from the generally cylindrical carrier roller body such that a weight of the upper strand of the endless linked chain is primarily carried by the engagement of the concave valleys with the cylindrical bushings of the endless linked chain.

2. The crawler track assembly of claim 1, wherein:
a pitch between adjacent teeth of the carrier sprocket is one-half a pitch between adjacent bushings of the endless linked chain; and
the plurality of teeth of the carrier sprocket is an odd number.

3. The crawler track assembly of claim 2, wherein:
the plurality of teeth of the carrier sprocket includes at least 11 teeth.

4. The crawler track assembly of claim 1, wherein:
the concave valleys of the carrier sprocket have a width parallel to the axis of rotation of at least 3.0 inches.

5. The crawler track assembly of claim 1, wherein:
the radial offset of the concave valleys from the generally cylindrical carrier roller body is at least 2.0 inches.

6. The crawler track assembly of claim 1, wherein:
the radial offset of the concave valleys from the generally cylindrical carrier roller body is at least 2.5 inches.

7. The crawler track assembly of claim 1, wherein:
the radial offset of the concave valleys from the generally cylindrical carrier roller body is sufficient to prevent the first and second rows of links from resting on the generally cylindrical carrier roller body.

8. The crawler track assembly of claim 1, wherein:
the carrier roller is formed as an integrally forged part including the generally cylindrical carrier roller body and the carrier sprocket.

9. The crawler track assembly of claim 1, wherein:
the plurality of teeth of the carrier sprocket includes at least 11 teeth.

10. The crawler track assembly of claim 1, wherein:
the at least one carrier roller includes a forward carrier roller and a rearward carrier roller.
